(19) United States
(12) Patent Application Publication
(10) Pub. No.: US 2009/0030657 A1
(43) Pub. Date: Jan. 29, 2009

(54) SURFACE TESSELATION OF SHAPE MODELS

(75) Inventors: Jens Von Berg, Hamburg (DE); Frans Andreas Gerritsen, Olsterwijk (NL); Juergen Weese, Aachen (DE); Cristian Lorenz, Hamburg (DE); Jochen Peters, Aachen (DE); Olivier Ecabert, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/097,141

(22) PCT Filed: Dec. 15, 2006
(86) PCT No.: PCT/IB06/54894

§ 371 Date: Sep. 11, 2008

(30) Foreign Application Priority Data
Dec. 16, 2005 (EP) 05112308.1

(51) Int. Cl. G06F 17/50

(52) U.S. Cl. 703/1

(57) ABSTRACT

The invention relates to a method (100) of and to a system (200) for determining a template mesh of a shape model on the basis of a plurality of instances of the shape model. The method of determining the template mesh of the shape model comprises an obtaining step (110) for obtaining the plurality of instances of the template mesh, a computing step (120) for computing a plurality of results on the basis of the plurality of instances of the shape model, a deciding step (130) for deriving a decision on the basis of the plurality of results, and a decimating step (140) for decimating the template mesh of the shape model on the basis of the decision, thereby determining the template mesh of the shape model. Thus, the template mesh of the shape model determined by the method of the invention better describes objects of interest at all locations.

This invention relates to a method of determining a template mesh of a shape model on the basis of a plurality of instances of the shape model.

The invention further relates to a template mesh of a shape model obtainable using said method.

The invention further relates to a method of adapting said template mesh of a shape model to an image dataset.

The invention further relates to a system for determining a template mesh of a shape model on the basis of a plurality of instances of the shape model.

The invention further relates to a system for adapting said template mesh of a shape model to an image dataset.

The invention further relates to an image acquisition apparatus comprising at least one of said systems.

The invention further relates to a workstation comprising at least one of said systems.

The invention further relates to a computer program product comprising program code means stored on a computer readable medium for performing at least one of said methods when said program product is run on a computer.

An embodiment of the method of the kind described in the opening paragraph is described in the article “Automated 3D PDM construction from segmented images using deformable models” by Michael R. Kaus, Vladimir Pekar, Cristian Lorenz, Roel Truyen, Steven Lobregt, and Jürgen Weese, in IEEE Transactions on Medical Imaging, 22 (8), pages 1005-1013, 2003, hereinafter referred to as Ref. 1, which is incorporated herein by reference. The input to the method is a learning shape representing an object of interest. The learning shape may be obtained from a segmented learning image. This learning shape is triangulated. A triangulation method is described, for example, in the article “Generation of point-based 3D statistical shape models for anatomical objects” by Cristian Lorenz and Nils Krahnstöver, in Computer Vision and Image Understanding 77 (2), pages 175-191, 2000, hereinafter referred to as Ref. 2, which is incorporated herein by reference. In this method the number of parameters of the triangular mesh representing the surface of the learning shape is minimized on the basis of and the selection of the triangular mesh vertices is guided by the local curvature of the surface of the learning shape. The determined instance of the triangular mesh representing the learning shape is used as the template mesh of the shape model. The determined template mesh comprises a plurality of vertices and edges.

The term “template mesh” refers to topological properties of the mesh such as the number of vertices and vertex connectivity while the term “instance of the template mesh” refers to both topological properties and geometrical properties of the mesh such as, but not limited to, coordinates of vertices. A shape model comprises a template mesh. Furthermore, the shape model may comprise other entities such as parameters of feature functions associated with faces of the template mesh. An instance of the shape model comprises an instance of the template mesh and may comprise other entities such as values of parameters of feature functions associated with faces of the instance of the template mesh.

A drawback of the method described in Ref. 1 is that the local resolution of the template mesh of the shape model for modeling an object of interest, such as a bone or an organ, is often insufficient for describing the object of interest at all locations.

It is an object of the invention to provide a method of the kind described in the opening paragraph that determines a template mesh of a shape model which better describes objects of interest at all locations.

This object of the invention is achieved in that the method of determining a template mesh of a shape model on the basis of a plurality of instances of the shape model comprises:

an obtaining step for obtaining the plurality of instances of the shape model;

a computing step for computing a plurality of results comprising a first result computed on the basis of a first instance of the shape model from the plurality of instances of the shape model and a second result computed on the basis of a second instance of the shape model from the plurality of instances of the shape model;

a deciding step for deriving a decision on the basis of the plurality of results comprising the first result and the second result; and

a decimating step for decimating the template mesh of the shape model on the basis of the decision, thereby determining the template mesh of the shape model.

According to the method of the current invention, the decision about decimating the template mesh of the shape model takes into account a plurality of instances of the shape model. First, a plurality of instances of the shape model is obtained in the obtaining step. Each instance of the shape model comprises an instance of the template mesh, e.g. of a triangular template mesh, representing the surface of an object of interest such as a humerus or a femur. In an exemplary case of a simple closed surface a result based on local curvature at a certain vertex of the template mesh is calculated for each instance of the template mesh. An exemplary estimate of local curvature at the certain vertex of an instance of the template mesh is described in the paper “Decimation of Triangle Meshes” by William J. Schroeder, Jonathan A. Zarge, and William E. Lorensen, in Proceedings of the ACM SIGGRAPH Conference 1992, pages 65-70, 1992, hereinafter referred to as Ref. 3, which is incorporated herein by reference. If the estimates satisfy a certain condition, for example, if the mean of the estimates is less than a predefined threshold then the decision to decimate the triangular template mesh is taken. The mesh is decimated on the basis of this decision in the decimating step as described in Ref. 3. On the other hand, if the estimates do not satisfy the certain condition, the decision is not to decimate the template mesh. Thus, the method of the current invention determines a template mesh of a shape model which better describes objects of interest at all locations.

In an embodiment of the method according to the invention, the first result comprises a first opinion on decimating the template mesh and the second result comprises a second opinion on decimating the template mesh. For example, the opinion may be a vote in favor of or against decimating the template mesh. The decision may be based on the ratio of the votes in favor of decimating the template mesh to the total number of votes.

In a further embodiment of the method according to the invention, the first result is based on a first evaluation of feature functions in the first instance of the shape model and the second result is based on a second evaluation of feature functions in the second instance of the shape model. In the exemplary case of a triangular template mesh, a decision to decimate the template mesh by removing a vertex may be taken if, for example, feature functions associated with triangles comprising said vertex are equivalent, e.g. have substantially identical parameter values, for each instance of the template mesh. The new feature function of a triangle obtained from triangulating the hole resulting from decimating the template mesh comprises said same parameters. Such criterion excludes the possibility of merging triangles with different feature functions, i.e. at a location with a potential for large variability of the local image appearance. Thus, the new feature function will determine a good target feature for adapting the template mesh in the image dataset.

In an embodiment of the method according to the invention, the method further comprises:

a first constructing step for constructing the shape model on the basis of a plurality of learning image datasets; and

a second constructing step for constructing an instance of the shape model on the basis of said plurality of learning image datasets.

In this embodiment the input to the method comprises a plurality of learning image datasets. The method advantageously comprises two constructing steps that allow constructing the shape model and the plurality of instances of the shape model on the basis of the plurality of learning image datasets. The shape model, the plurality of instances of the shape model, and/or the plurality of learning image datasets can be further used to determine the template mesh of the shape model according to the method of the current invention.

It is a further object of the invention to provide a template mesh of a shape model of the kind described in the opening paragraph that better describes objects of interest at all locations. This is achieved by a template mesh obtainable by any of the claimed methods of determining a template mesh of a shape model on the basis of a plurality of instances of the shape model.

It is a further object of the invention to provide a method of adapting a template mesh of a shape model of the kind described in the opening paragraph, which better describes objects of interest at all locations. This is achieved in that the method of adapting a template mesh of a shape model to an image dataset uses a template mesh of a shape model obtainable by any of the claimed methods of determining the template mesh of the shape model on the basis of a plurality of instances of the shape model.

It is a further object of the invention to provide a system of the kind described in the opening paragraph that determines a template mesh of a shape model which better describes objects of interest at all locations. This is achieved in that the system for determining a template mesh of a shape model on the basis of a plurality of instances of the shape model comprises:

an obtaining unit for obtaining the plurality of instances of the template mesh;

a computing unit for computing a plurality of results comprising a first result computed on the basis of a first instance of the shape model from the plurality of instances of the shape model and a second result computed on the basis of a second instance of the shape model from the plurality of instances of the shape model;

a deciding unit for deriving a decision on the basis of the plurality of results comprising the first result and the second result; and

a decimating unit for decimating the template mesh of the shape model on the basis of the decision, thereby determining the template mesh of the shape model.

It is a further object of the invention to provide a system for adapting the template mesh of a shape model of the kind described in the opening paragraph that is arranged to adapt a template mesh of a shape model which better describes objects of interest at all locations. This is achieved in that the system for adapting the template mesh of the shape model to an image dataset is arranged to use a template mesh of a shape model obtainable by the claimed system for determining a template mesh of a shape model on the basis of a plurality of instances of the shape model.

It is a further object of the invention to provide an image acquisition apparatus of the kind described in the opening paragraph that is capable of determining a template mesh of a shape model which better describes objects of interest at all locations. This is achieved in that the image acquisition apparatus comprises a system for determining a template mesh of a shape model on the basis of a plurality of instances of the shape model, the system comprising:

an obtaining unit for obtaining the plurality of instances of the template mesh;

a computing unit for computing a plurality of results comprising a first result computed on the basis of a first instance of the shape model from the plurality of instances of the shape model and a second result computed on the basis of a second instance of the shape model from the plurality of instances of the shape model;

a deciding unit for deriving a decision on the basis of the plurality of results comprising the first result and the second result; and

a decimating unit for decimating the template mesh of the shape model on the basis of the decision, thereby determining the template mesh of the shape model.

It is a further object of the invention to provide an image acquisition apparatus of the kind described in the opening paragraph that is capable of adapting a template mesh of a shape model which better describes objects of interest at all locations. This is achieved in that the image acquisition apparatus comprises the system for adapting the template mesh of the shape model to an image dataset, which system is arranged to use a template mesh of a shape model obtainable by the claimed system for determining a template mesh of a shape model on the basis of a plurality of instances of the shape model.

It is a further object of the invention to provide a workstation of the kind described in the opening paragraph that is capable of determining a template mesh of a shape model which better describes objects of interest at all locations. This is achieved in that the workstation comprises a system for determining a template mesh of a shape model on the basis of a plurality of instances of the shape model, the system comprising:

an obtaining unit for obtaining the plurality of instances of the template mesh;

a computing unit for computing a plurality of results comprising a first result computed on the basis of a first instance of the shape model from the plurality of instances of the shape model and a second result computed on the basis of a second instance of the shape model from the plurality of instances of the shape model;

a deciding unit for deriving a decision on the basis of the plurality of results comprising the first result and the second result; and

a decimating unit for decimating the template mesh of the shape model on the basis of the decision, thereby determining the template mesh of the shape model.

It is a further object of the invention to provide a workstation of the kind described in the opening paragraph that is capable of adapting a template mesh of a shape model which better describes objects of interest at all locations. This is achieved in that the workstation comprises the system for adapting the template mesh of the shape model to an image dataset, which system is arranged to use a template mesh of a shape model obtainable by the claimed system for determining a template mesh of a shape model on the basis of a plurality of instances of the shape model.

It is a further object of the invention to provide a computer program product of the kind described in the opening paragraph that determines a template mesh of a shape model which better describes objects of interest at all locations when said computer program product is run on a computer. This is achieved in that the computer program product comprises program code means, stored on a computer readable medium, for performing the following tasks:

obtaining the plurality of instances of the template mesh;

computing a plurality of results comprising a first result computed on the basis of a first instance of the shape model from the plurality of instances of the shape model and a second result computed on the basis of a second instance of the shape model from the plurality of instances of the shape model;

deriving a decision on the basis of the plurality of results comprising the first result and the second result; and

decimating the template mesh of the shape model on the basis of the decision, thereby determining the template mesh of the shape model.

It is a further object of the invention to provide a computer program product of the kind described in the opening paragraph that is capable of adapting a template mesh of a shape model which better describes objects of interest at all locations. This is achieved in that the computer program product comprises program code means stored on a computer readable medium, which is arranged to use a template mesh of a shape model obtainable by the claimed method of determining a template mesh of a shape model on the basis of a plurality of instances of the shape model when said program product is run on a computer.

Modifications and variations thereof, of the template mesh of the shape model, of the method of adapting a template mesh of a shape model, of the system for determining a template mesh of a shape model, of the system for adapting a template mesh of a shape model, of the image acquisition apparatus, of the workstations, and/or of the computer program products, which correspond to modifications of the method of determining a template mesh of a shape model and variations thereof, being described, can be carried out by a skilled person on the basis of the present description.

The method of the present invention is especially useful when applied to a shape model for representing an object of interest in a 3D image dataset. Such an image dataset can be routinely generated nowadays by various data acquisition modalities such as, but not limited to, Magnetic Resonance Imaging (MRI), Computed Tomography (CT), Ultrasound (US), Positron Emission Tomography (PET), and Single Photon Emission Computed Tomography (SPECT). However, this method can be also applied to a shape model representing an object of interest in any multidimensional image dataset.

These and other aspects of the invention will become apparent from and will be elucidated with respect to the implementations and embodiments described hereinafter and with reference to the accompanying drawings, wherein:

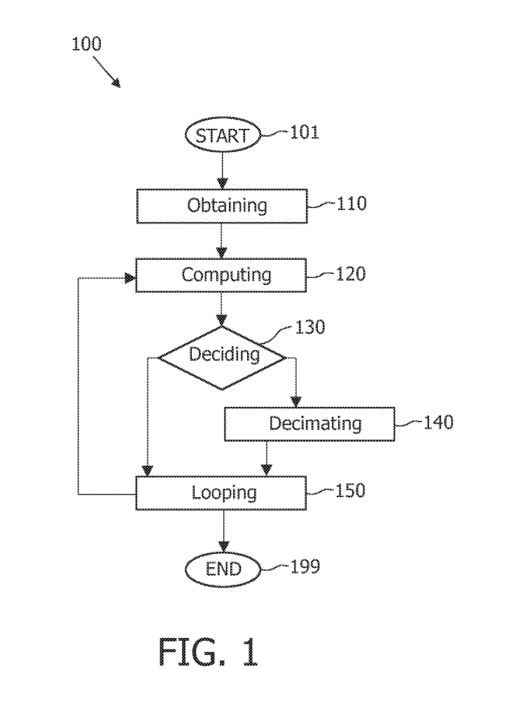

FIG. 1 shows a flowchart of an exemplary embodiment of a method of determining a template mesh of a shape model;

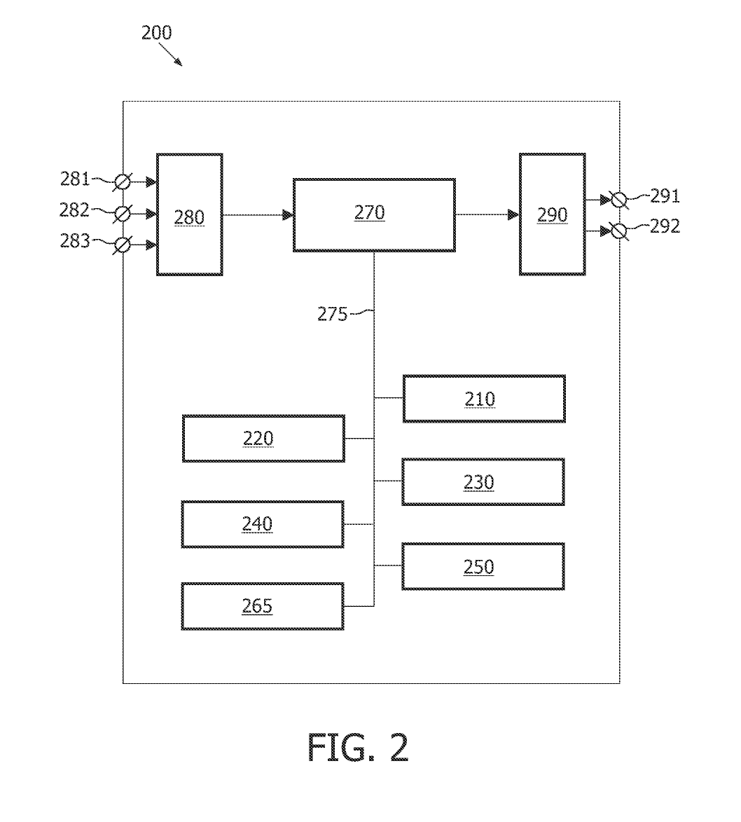

FIG. 2 schematically shows an exemplary embodiment of a system for determining a template mesh of a shape model;

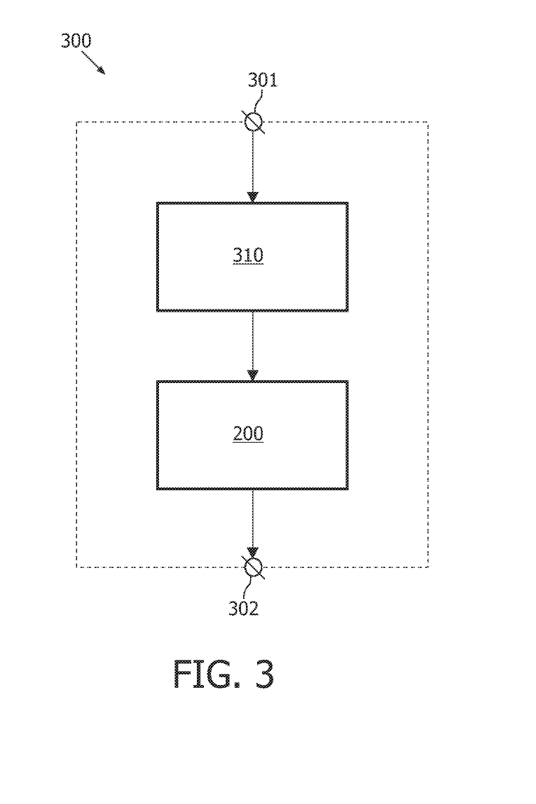

FIG. 3 schematically shows an exemplary embodiment of an image acquisition apparatus comprising the system for determining a template mesh of a shape model; and

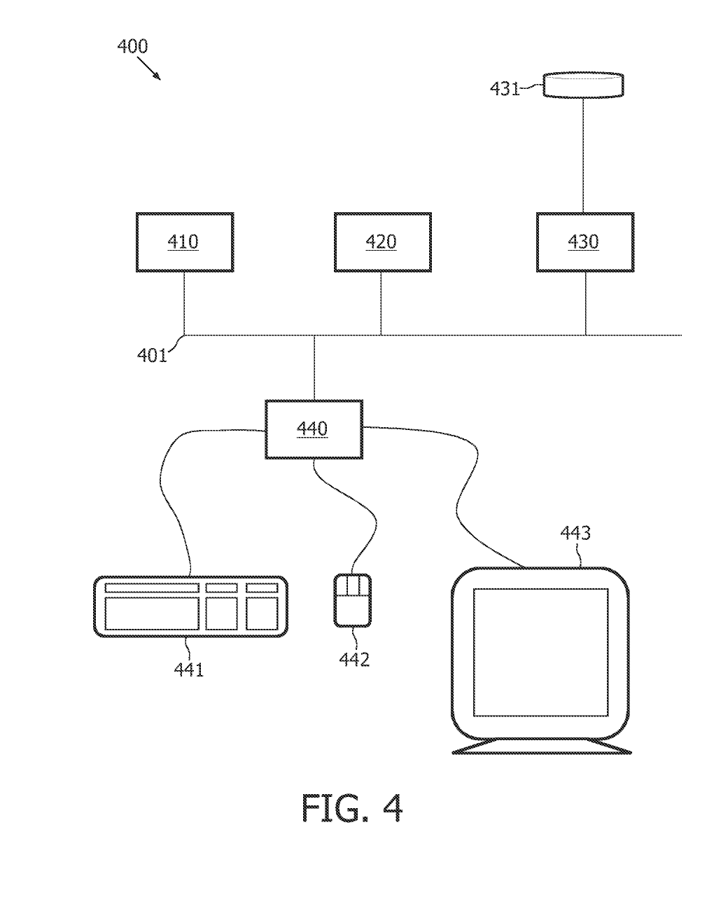

FIG. 4 schematically shows an exemplary embodiment of a workstation comprising the system for determining a template mesh of a shape model.

Same reference numerals are used to denote similar parts throughout the figures.

FIG. 1 shows a flowchart of an exemplary embodiment of the method 100 of determining a template mesh of a shape model. After a starting step 101 the method 100 continues to an obtaining step 110 for obtaining a plurality of instances of the shape model. After the obtaining step the method 100 continues to a computing step 120 for computing results on the basis of the instances of the shape model. The method 100 then continues to a deciding step 130, where a decision on decimating the template mesh of the shape model is made on the basis of the results computed in the computing step 120. If the decision is to decimate the template mesh of the shape model then the method 100 continues to a decimating step 140 for decimating the template mesh. After the decimating step 140 the method 100 continues to a looping step 150. If the decision is not to decimate the template mesh of the shape model then the method 100 omits the decimating step 140 and continues to the looping step 150. In the looping step 150 a condition for continuing decimating the template mesh, i.e. for continuing determining the template mesh of the shape model, is made. If the mesh is to be further decimated then the method returns to the computing step 120. Otherwise the method continues to a terminating step 199.

The input to the method 100 comprises a plurality of instances of the shape model. This plurality of instances of the shape model is obtained in the obtaining step 110. Each instance of the shape model comprises an instance of a template mesh. The template mesh comprises a collection of vertices, and in this context may be also referred to as a point-distribution model (PDM). Typically, the template mesh further comprises multiple edges. The ends of each edge are vertices of the template mesh. Such a template mesh may be represented by a list of vertices and a list of edges connecting vertices. Two vertices connected to each other by an edge may be referred to as neighboring vertices. Furthermore, the vertices and edges of the template mesh may define faces of the template mesh. If all faces are polygons then the template mesh is referred to as a polygonal template mesh. If all faces are triangles then the template mesh is referred to as a triangular template mesh or as a triangle template mesh. If each vertex of a mesh is an end of exactly three edges, then the template mesh is referred to as a simplex mesh.

Alternatively, the input to the method 100 comprises a plurality of learning image datasets and the instances of the shape model may be constructed in the obtaining step 110 from said plurality of learning image datasets. Each learning image dataset comprises an object of interest, e.g. a humerus or a femur, which is to be modeled by the shape model. The learning images may be, for example, selected by a user or may be automatically selected from a database of image datasets. The learning images may be segmented. Alternatively, the method of determining a template mesh of a shape model may further comprise a segmenting step for segmenting the object of interest in a learning image dataset. The object may be segmented using, for example, manual image segmentation.

The plurality of shape models obtained in the obtaining step 110 is used in the computing step 120 for computing a plurality of results comprising a first result computed on the basis of a first instance of the shape model from the plurality of instances of the shape model and a second result computed on the basis of a second instance of the shape model from the plurality of instances of the shape model. For example, the first result may comprise the distance from a certain vertex of the template mesh in the first instance of the template mesh to a first average plane, determined as the plane for which the sum of squares of distances of all vertices of the first instance of the template mesh connected by an edge to the certain vertex is minimal. Similarly, the second result may comprise an analogous distance computed for the second instance of the template mesh. A further result form the plurality of results may also comprise an analogous distance computed for a further instance of the template mesh.

In another example, a result from the plurality of results may comprise a measure of the internal solid angle defined by edges originating at a vertex in an instance of the template mesh. In yet another example, a result may comprise the maximum ratio of lengths of two edges originating at the certain vertex in an instance of the template mesh. In yet another example, a result may comprise a measure of local curvature as described in Section 3.2 of Ref. 2. A result from the plurality of results may also comprise multiple data such as a measure of the internal solid angle and the maximum ratio of lengths of two edges. The skilled person will understand that the described results illustrate the embodiments of the invention and do not limit the scope of the claims.

The method 100 further comprises a deciding step 130 for deriving a decision on the basis of a plurality of results comprising the first result and the second result. The decision to decimate the template mesh may be taken if the results from the plurality of results satisfy certain conditions. For example, if the mean, over all instances of the template mesh, of the distances from a certain vertex of the template mesh to the average plane as described in the previous example, is less than a threshold, then the decision may be to decimate the template mesh by removing the certain vertex from the template mesh. If this mean distance is greater than or equal to the predefined threshold, the decision may be not to remove the certain vertex from the template mesh. The certain condition may comprise a further requirement, e.g. that the maximum, over all instances of the template mesh, of the distances from the certain vertex of the template mesh to the average plane is less than double the mean distance and/or that the standard deviation of said distances is less than a threshold. The conditions, e.g. various thresholds, may be predefined or may be selectable by the user.

The method 100 further comprises a decimating step 140 for decimating the template mesh of the shape model on the basis of the decision derived in the deciding step 130. Various decimation algorithms are described in the literature. An overview of mesh decimation algorithms is presented in the article “A General Framework for Mesh Decimation” by L. Kobbelt, S. Campagna, and H. P. Seidel in Proceedings Graphics Interface '98, pages 311-18, October 1998, which is incorporated herein by reference. The choice of a template mesh, e.g. polygonal, triangular, or simplex, has an influence on the choice of the decimation algorithm. The choice of the decimation algorithm influences the choice of decimation criteria comprising the plurality of results to be computed for an instance of the template mesh in the computing step 120, the choice of conditions for deriving a decision on decimating the template mesh in the deciding step 130, and the decimating tasks performed in the decimating step 140.

The decimating tasks comprise removing vertices and/or edges of the template mesh, and creating a new template mesh by fixing, e.g. triangulating, the resulting hole, if required. For example, a simple algorithm for decimating a triangular mesh works by removing a certain vertex and the edges originating at the certain vertex, and triangulating a resulting hole by creating at least one new edge. This and other algorithms for decimating triangular meshes are described in Ref. 3. In addition, the instances of the decimated template mesh may be reconfigured to improve smoothness of and aspect ratio in the decimated template mesh. Furthermore, the instances of the decimated template mesh may be also re-adapted to the respective object of interest instances comprised in the respective learning image datasets. Alternatively, an instance of the decimated template mesh may be re-adapted to the respective instance of the template mesh.

The skilled person will appreciate that there are many decimating algorithms which may be useful for implementing the method of the invention and that the algorithms described above illustrate the invention and do not limit the scope of the claims.

In an embodiment of the method 100 according to the invention, the plurality of results comprises multiple results computed in the computing step 120. Multiple decisions are derived in the deciding step 130. Multiple vertices and/or edges are decimated in the decimating step 140. For example, the plurality of results computed in the computing step 120 may comprise measures of internal solid angles for each vertex and for each instance of the template mesh. Each vertex for which the measure of the solid angle satisfies a condition may be marked for deletion in the deciding step 130. All vertices marked for deletion and all edges originating at these vertices may be deleted from the template mesh in the decimating step 140.

In an embodiment of the method 100 according to the invention, the first result comprises a first opinion on decimating the template mesh and the second result comprises a second opinion on decimating the template mesh. The first and the second opinion may comprise, for example, a binary opinion such as “yes” or “no”, i.e. a vote in favor or against an act of decimating the template mesh of the shape model, or may comprise a grade, i.e. a numerical value, from a grade scale for evaluating the usefulness of an act of decimating the template mesh of the shape model. Other results from the plurality of results may also comprise such opinions or grades. The plurality of opinions or grades may be used in the deciding step 130. For example, the decision on decimating the template mesh may be derived from the Boolean product of binary opinions from the plurality of binary opinions, or from the algebraic sum of grades from the plurality of grades.

In an embodiment of the method 100 according to the invention, the first result is based on a first evaluation of feature functions in the first instance of the shape model and the second result is based on a second evaluation of feature functions in the second instance of the shape model. The feature functions are an important part of many shape models such as the one described in the article “Shape constrained deformable models for 3D medical image segmentation” by J. Weese, V. Pekar, M. Kaus, C. Lorenz, S. Lobregt, and R Truyen in Proc. IPMI, pages 380-387, Springer 2001, which is incorporated herein by reference. Advantageously, the feature functions of the shape model may be optimized using, for example, the feature optimization method described in the article “Feature Optimization Via Simulated Search for Model-Based Heart Segmentation” by Jochen Peters, Olivier Ecabert, and Jürgen Weese, in Lemke, Heinz U. (Ed.), Computer Assisted Radiology and Surgery, Proceedings CARS 2005, Amsterdam: Elsevier, 2005, pages 33-38, hereinafter referred to as Ref. 4, which is incorporated herein by reference. In the exemplary case of a triangular template mesh, the condition for decimating the template mesh by removing an edge, for example, may be that for each instance of the template mesh the feature functions associated with triangles comprising said edge are equivalent, e.g. have substantially the same parameter values. The new feature function of a triangle obtained from triangulating the hole resulting from decimating the template mesh comprises said same parameters. Such criterion excludes the possibility of merging triangles with different feature functions, i.e. at a location with a potential for large variability of the local image appearance. Thus, the new feature function will determine a good target feature for adapting the template mesh to the image dataset. A weaker condition for decimating the template mesh is that the feature functions are similar, i.e. that a measure of similarity of the feature functions is greater than a threshold. The threshold may be a predefined parameter of the method, may be computed by the method, or may be defined by the user. Other conditions may involve a statistical moment of a parameter of the feature functions such as a mean and/or a variance. The triangles obtained from triangulating the hole in the decimated mesh may inherit an average feature function, which may be defined by the means of parameters of the feature functions of merged triangles. Alternatively, the feature functions may be determined using the method of Ref. 4.

In an embodiment of the method 100 according to the invention, the decision on decimating the triangular template mesh is based on a probability of co-occurrence of a feature function or of a parameter thereof, in neighboring triangles, i.e. in triangles sharing an edge. The probability of co-occurrence of a feature function in neighboring triangles may be defined as the ratio of the number of instances of the shape model wherein said neighboring triangles have identical feature functions over the total number of instances of the shape model. If the probability exceeds a threshold, the shared edge may be removed from the mesh.

The skilled person will appreciate that feature functions are just one of the many characteristics of a shape model and/or of instances of the shape model, and that other characteristics may be advantageously used in other embodiments of the inventions.

In an embodiment of the method 100 according to the invention, the obtaining step 110 comprises:

a first constructing step for constructing the shape model on the basis of the plurality of learning image datasets; and

a second constructing step for constructing an instance of the shape model on the basis of the plurality of learning image datasets.

In the first constructing step a template mesh of a shape model comprising a point distribution model is constructed on the basis of a segmented learning image dataset from the plurality of learning image datasets. To generate the point distribution model of a surface representing a delineated object of interest comprised in the learning image it is necessary to select a subset of voxels from the learning image dataset as surface points. A surface voxel may be defined as an object voxel that is 26-connected to a background voxel. Optionally, to obtain a complete parameterization of the object surface, the set of surface points representing voxels may be triangulated. This may be achieved using, for example, the Delaunay triangulation described in Chapter 9 of “Computational Geometry, Applications and Algorithms” by M. de Berg, M. van Kreveld, M. Overmans, and O. Schwarzkopf, Springer, 1997, which is incorporated herein by reference. Other parameters of the shape model known to the skilled person, such as a feature function, may be also assigned to a triangle of the triangular mesh of the shape model. This may be achieved using the algorithm of Ref. 4, for example.

In the second constructing step a plurality of instances of the shape model is instantiated. It is worth pointing out that an instance of the shape model is identical to the shape model constructed in the first constructing step using the segmented learning image dataset from the plurality of learning image datasets. Every remaining instance of the shape model may be obtained by adapting the shape model to a remaining learning image dataset from the plurality of the learning image datasets, as described in Sections II.B and II.C of Ref. 1, for example. Alternatively, a landmark-based registration method described in Section 4 of Ref. 2 may be employed. The output of the second constructing step is a plurality of instances of the shape model.

The skilled person will understand that there are other definitions and/or other methods of constructing the shape model, which may be advantageously used by the method 100 of the current invention. For example, some models may comprise a triangular mesh and other may comprise a simplex mesh. The shape models used in this description serve the purpose of illustrating the invention and do not limit the scope of the claims.

In an embodiment of the method 100 according to the invention, the obtained template mesh and the plurality of its instances are duplicated as the candidate template mesh and the plurality of instances of the candidate template mesh. This task may be carried out, for example, in the computing step 120. Also a reference template mesh and a plurality of instances of the reference template mesh are stored. The reference template mesh and the plurality of instances of the reference template mesh may be identical with the template mesh and a plurality of its instances obtained in the obtaining step 110, i.e. with the high-resolution template mesh computed in the first constructing step and with its instances computed in the second constructing step, respectively. The candidate template mesh is decimated in the computing step 120. The decimated candidate template mesh is then adapted to each learning image dataset from the plurality of learning image datasets. The plurality of results further computed in the computing step 120 may comprise volumetric differences between the instances of the candidate template mesh and the respective instances of the reference template mesh. The volumetric differences may be defined, for example, as the sum of volumes of regions sandwiched between the instance of the candidate template mesh and the respective instance of the reference template mesh, or as the volume of the set-theoretical symmetric difference of the shape bounded by the instance of the candidate template mesh and of the shape bounded by the respective instance of the reference template mesh. In the deciding step 130 the volumetric differences of the instances of the two template meshes may be evaluated. For example, the sum of the volumetric differences of the instances of the two template meshes may be compared to a threshold. The candidate mesh may be then accepted or rejected as the template mesh on the basis of this comparison in the decimating step 140.

In an embodiment of the method 100 according to the invention, the method 100 further comprises a setting step for setting a criterion for decimating the template mesh. For example, the criterion may be that each result from the plurality of results to be computed in the computing step 120 is less than a threshold. Another criterion may be that the mean of the results from the plurality of results computed in the computing step 120 is greater than a threshold. Another criterion may be that the results from the plurality of results computed in the computing step 120 are identical. Another criterion may be that a cost function calculated on the basis of the results from the plurality of results computed in the computing step 120 attains an optimum. An example of a cost function is the number of parameters defining the template mesh. The parameters defining the optimum of the cost function may be required to satisfy some conditions, which do not allow the instances of the template mesh to be very different from the modeled instances of the object of interest. The criterion may comprise multiple subcriteria. The criterion set in the setting step influences the implementation of the computing step 120, of the deciding step 130, of the decimating step 140, and of the looping step 150. A suitable implementation of at least one of these steps may be automatically selected by the method on the basis of the condition set in the setting step. Optionally, a suitable implementation of at least one of these steps may be interactively determined by the user in the setting step, for example.

The computing step 110, the deciding step 120, and the decimating step 130 may be iterated. The number of iterations may be defined by an iteration condition. In an embodiment of the method 100 according to the invention, the method 100 comprises a looping step 150 for checking the iteration condition. The iteration condition may be based, e.g. on the maximum number of iterations, on the number of vertices in the template mesh, on an evaluation of a cost function, and/or on an evaluation of the decimated template mesh. For example, if the number of negative decisions on decimating the template mesh exceeds a threshold then the iteration can be terminated. The skilled person will understand that there may be many other conditions for terminating the iteration and that multiple conditions can be combined using Boolean and/or numerical expressions.

The order of steps in the described embodiments of the method 100 of the current invention is not mandatory, the skilled person may change the order of some steps or perform some steps concurrently using threading models, multi-processor systems or multiple processes without departing from the concept as intended by the present invention. Optionally, two or more steps of the method 100 of the current invention may be combined into one step. Optionally, a step of the method 100 of the current invention may be split into a plurality of steps.

The method 100, such as the one illustrated by the flowchart diagram in FIG. 1, can be implemented as a computer program product and can be stored on any suitable medium such as, for example, magnetic tape, magnetic disk, or optical disk. This computer program can be loaded into a computer arrangement comprising a processing unit and a memory. The computer program product, after being loaded, provides the processing unit with the capability to carry out the steps of the method 100.

FIG. 2 schematically shows an exemplary embodiment of a system 200 for determining a template mesh of a shape model on the basis of a plurality of instances of the shape model comprising:

an obtaining unit 210 for obtaining the plurality of instances of the template mesh;

a computing unit 220 for computing a plurality of results;

a deciding unit 230 for deriving a decision on the basis of the plurality of results;

a decimating unit 240 for decimating the template mesh of the shape model on the basis of the decision;

a looping unit 250 for controlling iterations;

a user interface 265 for communicating with the system 200; and

a memory unit 270 for storing data.

In the embodiment of the system 200 shown in FIG. 2, there are three input connectors 281, 282 and 283 for the incoming data. The first input connector 281 is arranged to receive data coming in from data storage such as a hard disk, a magnetic tape, flash memory, or an optical disk. The second input connector 282 is arranged to receive data coming in from a user input device such as, but not limited to, a mouse or a touch screen. The third input connector 283 is arranged to receive data coming in from a user input device such as a keyboard. The input connectors 281, 282 and 283 are connected to an input control unit 280.

In the embodiment of the system 200 shown in FIG. 2, there are two output connectors 291 and 292 for the outgoing data. The first output connector 291 is arranged to output the data to data storage such as a hard disk, a magnetic tape, flash memory, or an optical disk. The second output connector 292 is arranged to output the data to a display device. The output connectors 291 and 292 receive the respective data via an output control unit 290.

The skilled person will understand that there are many ways to connect input devices to the input connectors 281, 282 and 283 and the output devices to the output connectors 291 and 292 of the system 200. These ways comprise, but are not limited to, a wired and a wireless connection, a digital network such as a Local Area Network (LAN) and a Wide Area Network (WAN), the Internet, a digital telephone network, and an analogue telephone network.

In an embodiment of the system 200 according to the invention, the system 200 comprises a memory unit 270. The system 200 is arranged to receive an input data from external devices via any of the input connectors 281, 282, and 283 and to store the received input data in the memory unit 270. Loading the data into the memory unit 270 allows a quick access to relevant data portions by the units of the system 200. The input data may comprise a plurality of instances of a shape model and/or a plurality of learning image datasets. The memory unit 270 may be implemented by devices such as a Random Access Memory (RAM) chip, a Read Only Memory (ROM) chip, and/or a hard disk. Preferably, the memory unit 270 comprises a RAM for storing input data and/or output data. The memory unit 270 is also arranged to receive data from and to deliver data to the units of the system 200 comprising the obtaining unit 210, the computing unit 220; the deciding unit 230, the decimating unit 240, the looping unit 250, and the user interface 265 via a memory bus 275. The memory unit 270 is further arranged to make the data available to external devices via any of the output connectors 291 and 292. Storing the data from the units of the system 200 in the memory unit 270 advantageously improves the performance of the units of the system 200 as well as the rate of transfer of data from the units of the system 200 to external devices.

Alternatively, the system 200 does not comprise the memory unit 270 and the memory bus 275. The input data used by the system 200 is supplied by at least one external device, such as external memory or a processor, connected to the units of the system 200. Similarly, the output data produced by the system 200 is supplied to at least one external device, such as external memory or a processor, connected to the units of the system 200. The units of the system 200 are arranged to receive the data from each other via internal connections or via a data bus.

In a further embodiment of the system 200 according to the invention, the system 200 comprises a user interface 265 for communicating with the system 200. The user interface 265 may comprise a display unit for displaying data to the user and a selection unit for making selections. Combining the system 200 with a user interface 265 allows the user to communicate with the system 200. The user interface 265 may be arranged to accept a criterion for decimating the template mesh selected by the user. The user interface 265 may be further arranged to display an instance of the template mesh. Optionally, the user interface may comprise a plurality of modes of operation of the system 200 such as a mode using one of multiple decimation algorithms, which may be implemented by the system 200. The skilled person will understand that more functions can be advantageously implemented in the user interface 265 of the system 200.

Alternatively, the system may employ an external input device and/or an external display connected to the system 200 via the input connectors 282 and/or 283 and the output connector 292. The skilled person will also understand that there exist many user interface devices that can be advantageously comprised in the system 200 of the current invention.

FIG. 3 schematically shows an embodiment of the image acquisition apparatus 300 employing the system 200 of the invention, said image acquisition apparatus 300 comprising an image acquisition unit 310 connected via an internal connection with the system 200, an input connector 301, and an output connector 302. This arrangement advantageously increases the capabilities of the image acquisition apparatus 300 providing said image acquisition apparatus 300 with advantageous capabilities of the system 200 for determining a template mesh of a shape model and for using a template mesh of a shape model obtainable by the system 200 for image segmentation. Examples of image acquisition apparatus comprise, but are not limited to, a CT system, an X-ray system, an MRI system, an US system, a PET system, and a SPECT system.

FIG. 4 schematically shows an embodiment of a workstation 400. The workstation comprises a system bus 401. A processor 410, a memory 420, a disk input/output (I/O) adapter 430, and a user interface (UI) 440 are operatively connected to the system bus 401. A disk storage device 431 is operatively coupled to the disk I/O adapter 430. A keyboard 441, a mouse 442, and a display 443 are operatively coupled to the UI 440. The system 200 of the invention, implemented as a computer program, is stored in the disk storage device 431. The workstation 400 is arranged to load the program and input data into memory 420 and execute the program on the processor 410. The user can input information to the workstation 400 using the keyboard 441 and/or the mouse 442. The workstation is arranged to output information to the display device 443 and/or to the disk 431. The skilled person will understand that there are numerous other embodiments of the workstation 400 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a suitable programmed computer. In the system claims enumerating several units, several of these units can be embodied by one and the same item of hardware or software. The usage of the words first, second and third, et cetera does not indicate any ordering. These words are to be interpreted as names.

1. A method of determining a template mesh of a shape model on the basis of a plurality of instances of the shape model, the method comprising:
an obtaining step for obtaining the plurality of instances of the template mesh;
a computing step for computing a plurality of results comprising a first result computed on the basis of a first instance of the shape model from the plurality of instances of the shape model and a second result computed on the basis of a second instance of the shape model from the plurality of instances of the shape model;
a deciding step for deriving a decision on the basis of the plurality of results comprising the first result and the second result; and
a decimating step for decimating the template mesh of the shape model on the basis of the decision, thereby determining the template mesh of the shape model.

2. A method as claimed in claim 1 wherein the first result comprises a first opinion on decimating the template mesh and the second result comprises a second opinion on decimating the template mesh.

3. A method as claimed in claim 1 wherein the first result is based on a first evaluation of feature functions in the first instance of the shape model and the second result is based on a second evaluation of feature functions in the second instance of the shape model.

4. A method as claimed in claim 1 wherein the instance obtaining step comprises:
a first constructing step for constructing the shape model on the basis of a plurality of learning image datasets; and
a second constructing step for constructing an instance of the shape model on the basis of said plurality of learning image datasets.

5. A template mesh of a shape model obtainable by the method as claimed in claim 1.

6. A method of adapting the template mesh of the shape model as claimed in claim 1 to an image dataset.

7. A system for determining a template mesh of a shape model on the basis of a plurality of instances of the shape model, the system comprising:
an obtaining unit for obtaining the plurality of instances of the template mesh;
a computing unit for computing a plurality of results comprising a first result computed on the basis of a first instance of the shape model from the plurality of instances of the shape model and a second result computed on the basis of a second instance of the shape model from the plurality of instances of the shape model;
a deciding unit for deriving a decision on the basis of the plurality of results comprising the first result and the second result; and
a decimating unit for decimating the template mesh of the shape model on the basis of the decision, thereby determining the template mesh of the shape model.

8. A system for adapting the template mesh of the shape model as claimed in claim 1 to an image dataset.

9. An image acquisition apparatus comprising a system as claimed in claim 1.

10. A workstation comprising a system as claimed in claim 1.

11. A computer program product comprising program code means stored on a computer readable medium for performing the method as claimed in claim 1 when said program product is run on a computer.
